(19) United States
(12) Patent Application Publication
(10) Pub. No.: US 2007/0117449 A1
(43) Pub. Date: May 24, 2007

(54) Clamp

(76) Inventor: Keith Michael Hansford, Weymouth, Dorset (GB)

Correspondence Address: Marina Larson & Associates, LLC, P.O. BOX 4928, DILLON, CO, 80435, US

(21) Appl. No.: 11/560,992

(22) Filed: Nov. 17, 2006

(30) Foreign Application Priority Data
Nov. 18, 2005 (GB) 0523503.1
Oct. 24, 2006 (GB) 0621116.3

(51) Int. Cl. H01R 13/00

(52) U.S. Cl. 439/480

(57) ABSTRACT

A clamp for securing a circuit board 10 beneath a stencil whilst solder is printed onto pads 11 on the circuit board 10, comprises a mount 12 and an elongate clamping member 17, in the form of a metal strip, mounted in a mouth 18 of the of the mount 12. A longitudinal side edge of the clamping member 17 extends outwardly from the side surface of the mount 12, the upper surface of the clamping member 17 lying in substantially the same plane as the upper surface of the mount 12. The projecting longitudinal side edge of the clamping member 17 comprises a plurality of frangible regions, which can be broken off so that the clamping member 17 only engages points on the side edge of the circuit board 10 which are free of pads 11.

### BACKGROUND OF THE INVENTION

1. Field of the Invention

The present invention relates to a clamp and more particularly but not solely to a clamp for clamping a circuit board during the printing of solder paste onto the circuit board or during placing of components onto the circuit board.

2. Related Background Art

The manufacture of circuit boards involves many processes, one of which is screen-printing the surface of the board with pads of solder paste. The thickness and position of these pads of solder is finely controlled.

During the screen-printing process, the circuit board has to be held down beneath a stencil. Typically this is achieved by clamping the board along its opposite side edges which extend axially of the direction of travel. Known clamps generally engage the upper surface of the board along regions which are not populated with components. However, a disadvantage of leaving regions unpopulated for the clamping devices is that the available area for positioning components is not maximised, which can be a problem in small circuit boards.

We have now devised a clamp which alleviates the above-mentioned problem.

### SUMMARY OF THE INVENTION

In accordance with this invention, as seen from a first aspect, there is provided a clamp comprising a one-piece elongate clamping member having a plurality of frangible regions along one longitudinal side thereof.

In use, the clamping member can be configured so that it only engages points on the side edge of the board which are free of pads. In this manner there is no requirement to leave the entire edge region unpopulated for the clamping member and as such, the available area for positioning components can be maximised.

Preferably the clamping member comprises an elongate strip, the strip being mounted in a mount of the clamp such that said longitudinal side edge of the strip projects from the mount.

Preferably the clamping member is formed of a resiliently flexible material, which is preferably metal and most preferably high carbon spring steel.

Preferably each frangible region of the clamping member is connected to a longitudinally extending body of the clamping member by a frangible web, the frangible web preferably comprising a longitudinally extending line of reduced material thickness.

Preferably said longitudinally extending line of reduced material thickness is contained with the mount.

Preferably adjacent frangible regions are connected to each other by a frangible web, the frangible web preferably comprising a transversely extending line of reduced material thickness.

Preferably the clamp is generally planar, said longitudinal side edge being inclined relative to the generally planar portion.

Circuit boards are printed by raising the pair of mounts upwardly against the underside of a stencil once they have engaged the respective opposite side edges of the board. The quality and height of the printed solder pads is partly governed by the spacing between the upper surface of the board and the underside of the stencil. Accordingly, the height of the clamp above the board needs to be minimised in order to allow the board to brought as near to face-to-face contact with the stencil as possible.

Accordingly, in accordance with this invention, as seen from a second aspect, there is provided a clamp comprising a mount and at least one clamping member, the mount comprising a side surface and an upper surface, the or each clamping member extending outwardly from the side surface of the mount, the upper surface of the or each clamping member lying in substantially the same plane as the upper surface of the mount.

Preferably the or each clamping member comprises a generally flat sheet of material mounted in a mouth defined between upper and lower portions of the mount, the mouth being upwardly inclined towards the opening from which the or each clamping member extends.

Preferably, the projecting portion of the or each clamping member is downwardly inclined, preferably by an angle which is at least as great as the angle of upward inclination of the mouth.

In one embodiment the mount is elongate and supports a plurality of clamping members along its length, the clamping members being positional at selected positions longitudinally of the mount. In this manner, the clamp can be configured so that it only engages points on the side edge of the board which are free of pads.

In an alternative embodiment, the mount is elongate and supports a one-piece elongate clamping member having a plurality of frangible regions along one longitudinal side thereof.

The current invention thus provides a means of clamping a circuit board in position by way of a formed, single thickness clamping member in the form of a foil, which is mounted in a mount and retained in position by a clamping mechanism. These foils are normally used in multiples of 2 or 4.

By allowing a more effective and positive clamping of the board close to the edge and with the added ability to selectively remove segments of the single thickness formed foil to give clearance to any solder pads which are close to the edge of the board, the invention overcomes a major failing of current clamping systems.

### BRIEF DESCRIPTION OF THE DRAWINGS

Embodiments of this invention will now be described by way of an example only and with reference to the accompanying drawings, in which:

FIG. 1 is perspective view of a first embodiment of clamp in accordance with the present invention, when in use;

FIG. 2 is an enlarged view of one end of the clamp of FIG. 1;

FIG. 3 is an end view of the clamp of FIG. 1 when in use;

FIG. 4 is a perspective view of a strip portion of the clamp of FIG. 1;

FIG. 5 is an enlarged view of one end of the strip portion of FIG. 4;

FIG. 6 is an enlarged view of one end of the strip portion of FIG. 4, illustrating how the strip portion is configured for use;

FIG. 7 is an end view of second embodiment of clamp in accordance with the present invention;

FIG. 8 is an end view of third embodiment of clamp in accordance with the present invention; and

FIG. 9 is a plan view of a strip portion of a fourth embodiment of clamp in accordance with the present invention.

### DETAILED DESCRIPTION OF THE PREFERRED EMBODIMENTS

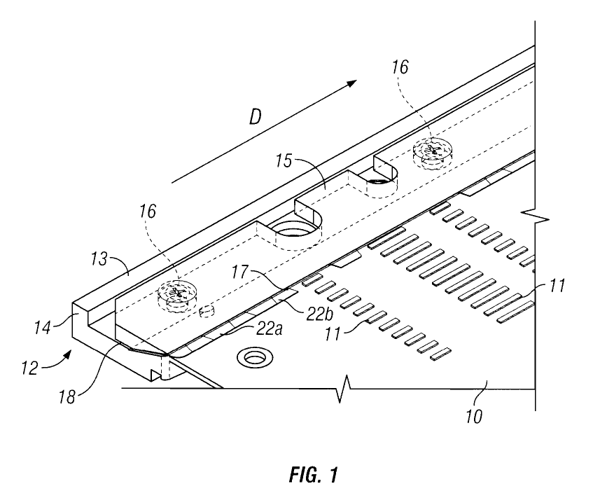

Referring to FIG. 1 of the drawings, a circuit board 10 comprises a pattern of pads 11 or other conductive areas. The circuit board 10 is advanced on a conveyor (not shown) in direction D to a printing station where the board 10 is clamped under a stencil. A printing head then passes over the stencil to deposit solder paste (or other viscous material) onto the pads. It will be appreciated that some of the pads 11 are close to the edge of the board 10 and must be kept clear during board clamping and subsequent printing.

The printing station comprises a pair of parallel elongate clamps 12 extending axially of the conveyor for engaging respective opposite lateral side edges of the board 10. An actuator (not shown) at the printing station lifts the board 10 upwardly against the clamps 12 to securely retain the board whilst the printing is performed.

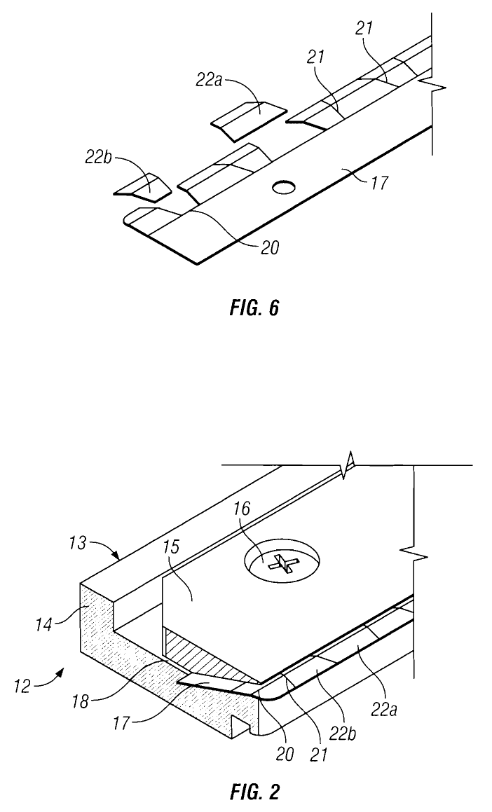

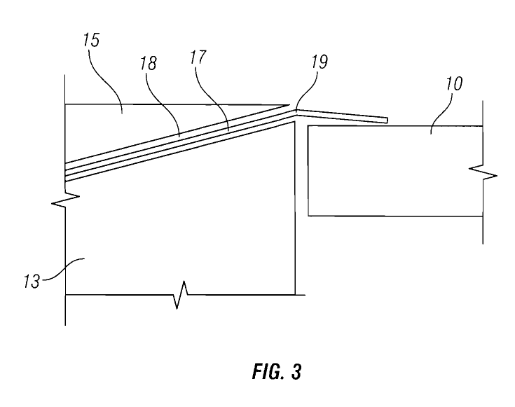

Referring to FIGS. 2 and 3 of the drawings, each clamp 12 comprises a mount portion having an elongate channel-section base member 13. An upstanding shoulder 14 extends along the rear edge of the base member 13. The upper surface of the base member 13 is inclined upwardly along the front edge thereof. The mount portion of the clamp 12 also comprises an elongate retaining member 15 which is secured to the upper surface of the base member 13 by screws 16. The cross-sectional profile of the under surface of the retaining member 15 corresponds with the cross-sectional profile of the upper surface of the base member 13.

The clamp 12 also comprises an elongate strip portion 17 which is securely clamped in the upwardly inclined mouth 18 that is defined between the base member 13 and the retaining member 15.

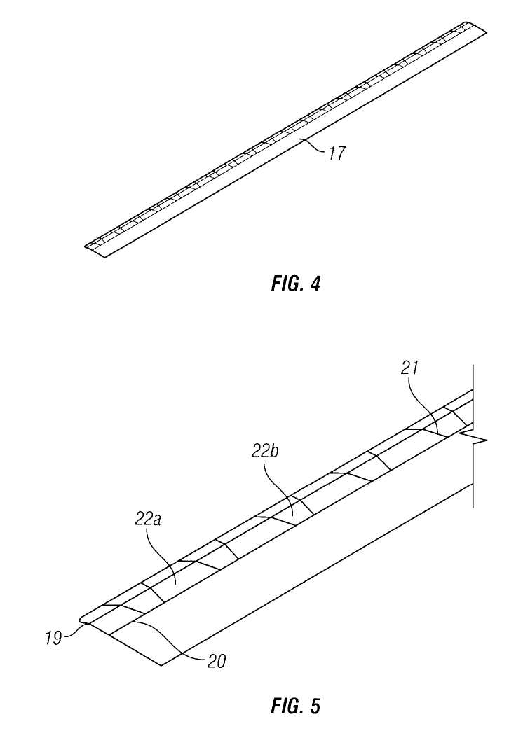

Referring to FIGS. 4 and 5 of the drawings, the strip portion 17 comprises a one-piece member of high carbon spring steel. The strip 17 is generally planar apart from its outer longitudinal side edge, which is folded downwardly by approximately 20 degrees at 19. The planar portion is partially etched along a line 20 which extends longitudinally thereof. A plurality of partially etched lines 21 extend transverse the strip portion 17 from respective points disposed along the length of the longitudinally-extending etched line 20. The successive lines 21 extend alternately at angles of approximately +/−10 degrees to the transverse axis of the strip portion 17, thereby defining alternate segments 22a,22b of complementary trapezoidal shape along the outer side edge of the strip portion 17.

In use, referring to FIG. 6 of the drawings, selected segments 22a, 22b can be detached from the outer side edge of the strip portion 17 by breaking along the partially etched lines 20,21. As shown in FIG. 1 of the drawings, the segments can be broken away at points where the strip portion 17 would interfere with pads 11 on the circuit board 10.

The formed strip portion 17 is clamped between the base member 13 and the retaining member 15 such that the longitudinally-extending etched line 20 is contained beneath the retaining member 15 to prevent the risk of the segments becoming detached in use.

The downwardly outer edge of the strip portion 17 applies a bias to the upper surface of the board 10 when the latter is raised upwardly in the printing station, so that the board 10 is gripped more positively. The underside of the outer side edge of the strip portion 17 may comprise a relief pattern to enhance the grip on the board 10.

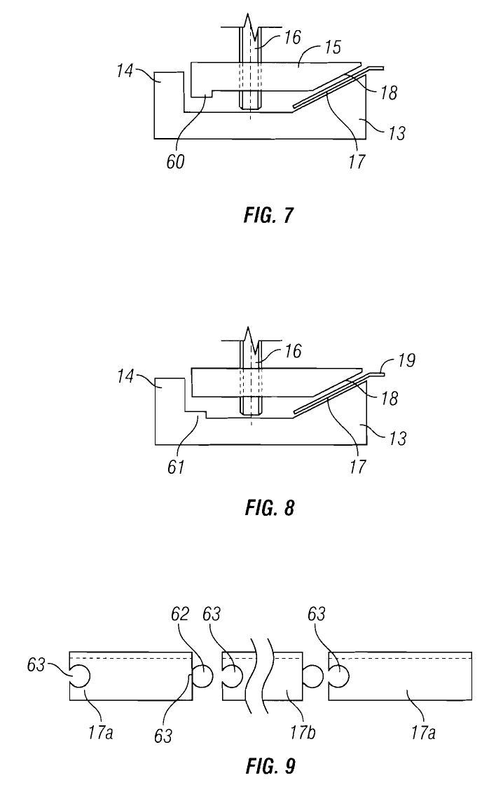

Referring to FIG. 7 of the drawings, in order achieve a more positive grip on the strip portion 17, a depending lip 60 or other formation may be disposed on the bottom surface of the elongate retaining member 15 adjacent the rear edge thereof, such that the elongate retaining member 15 is pulled more positively downwardly along its front edge when the screws 16 are tightened. Referring to FIG. 8 of the drawings, the same effect can be obtained by providing a lip 61 or other formation on the rear edge of the upper surface of the channel of the base member 13 of the clamp.

Referring to FIG. 9 of the drawings, the strip portion 17 may comprise a plurality of shorter sections e.g. 17a, 17b . . . 17n arranged for connecting end-to-end: this allows the sections 17 to slide along the mouth 18 of the clamp, so that they can be positioned with greater precision. The shorter sections 17 can also be provided with formations 62,63 at their respective opposite ends for engaging complementary formations on the ends of adjacent sections. In this manner adjacent sections 17 can be interengaged together, for example via a jigsaw or dove tail joint, to make a larger section. The male formation 62 of the joint has a half etched line 63, enabling it to be broken off the end section e.g. 17n, so that the section can be pushed up against an end stop or other formation on the clamp.

The strip portion 17 may have a protective coating to reduce corrosion. The strip portion 17 may also be electroless nickel plated.

Whilst the embodiment has been described with reference to screen printers or stencil printers that print solder paste onto circuit boards, it will be appreciated that the clamp of the present invention can be used with electronic substrates other than circuit boards and with machines other than board printers, such as pick and place machines.

While the preferred embodiments of the invention have been shown and described, it will be understood by those skilled in the art that changes of modifications may be made thereto without departing from the true spirit and scope of the invention.

1. A clamp comprising a one-piece elongate clamping member having a plurality of frangible regions along one longitudinal side thereof.

2. A clamp as claimed in claim 1, in which said one-piece elongate clamping member comprises an elongate strip, the strip being mounted in a mount of the clamp such that said longitudinal side edge of the strip projects from the mount.

3. A clamp as claimed in claim 1, in which the clamping member is formed of a resiliently flexible material.

4. A clamp as claimed in claim 1, in which the clamping member is formed of a resiliently flexible metal.

5. A clamp as claimed in claim 1, in which the clamping member is formed of high carbon spring steel.

6. A clamp as claimed in claim 1, in which each frangible region of the clamping member is connected to a longitudinally extending body of the clamping member by a frangible web.

7. A clamp as claimed in claim 6, in which the frangible web comprises a longitudinally extending line of reduced material thickness.

8. A clamp as claimed in claim 2, in which the frangible web comprises a longitudinally extending line of reduced material thickness and in which said longitudinally extending line of reduced material thickness is contained with said mount.

9. A clamp as claimed in claim 1, in which adjacent frangible regions are connected to each other by a frangible web.

10. A clamp as claimed in claim 9, in which the frangible web interconnecting adjacent sections comprises a transversely extending line of reduced material thickness.

11. A clamp as claimed in claim 1, in which the clamp is generally planar, said longitudinal side edge being inclined relative to the generally planar portion.

12. A clamp as claimed in claim 2, comprising a plurality of strips mounted in said mount.

13. A clamp as claimed in claim 12, in which said strips are mounted end-to-end.

14. A clamp as claimed in claim 13, in which said strips are interconnected.

15. A clamp as claimed in claim 14, in which adjacent strips comprise complementary engaging formations at their opposite ends.

16. A clamp as claimed in claim 15, in which a said formation comprises a projection, said projection being connected to the strip by a frangible web.

17. A clamp as claimed in claim 2, in which the mount comprises a side surface and an upper surface, the or each clamping member extending outwardly from the side surface of the mount, the upper surface of the or each clamping member lying in substantially the same plane as the upper surface of the mount.

18. A clamp as claimed in claim 17, in which the or each clamping member comprises a generally flat sheet of material mounted in a mouth defined between upper and lower portions of the mount, the mouth being upwardly inclined towards the opening from which the or each clamping member extends.

19. A clamp as claimed in claim 18, in which the projecting portion of the or each clamping member is downwardly inclined, preferably by an angle which is at least as great as the angle of upward inclination of the mouth.

20. A clamp comprising a mount and at least one clamping member, the mount comprising a side surface and an upper surface, the or each clamping member extending outwardly from the side surface of the mount, the upper surface of the or each clamping member lying in substantially the same plane as the upper surface of the mount.

21. A clamp as claimed in claim 20, in which the or each clamping member comprises a generally flat sheet of material mounted in a mouth defined between upper and lower portions of the mount, the mouth being upwardly inclined towards the opening from which the or each clamping member extends.

22. A clamp as claimed in claim 21, in which the projecting portion of the or each clamping member is downwardly inclined, preferably by an angle which is at least as great as the angle of upward inclination of the mouth.

23. A clamp as claimed in claim 20, in which the mount is elongate and supports a plurality of clamping members along its length, the clamping members being positional at selected positions longitudinally of the mount.

24. A clamp as claimed in claim 20, in which the mount is elongate and supports a one-piece elongate clamping member having a plurality of frangible regions along one longitudinal side thereof.
